(19) United States
(12) Patent Application Publication
(10) Pub. No.: US 2024/0090046 A1
(43) Pub. Date: Mar. 14, 2024

(54) COORDINATED TIME DOMAIN MULTIPLE ACCESS (TDMA) AMONG ACCESS POINTS (APS) WITH DIFFERENT CHANNELS

(71) Applicant: QUALCOMM Incorporated, San Diego, CA (US)

(72) Inventors: Yanjun Sun, San Diego, CA (US); George Cherian, San Diego, CA (US); Alfred Asterjadhi, San Diego, CA (US); Abhishek Pramod Patil, San Diego, CA (US); Abdel Karim Ajami, Lakeside, CA (US); Sai Yiu Duncan Ho, San Diego, CA (US); Gaurang Naik, San Diego, CA (US); Maarten Menzo Wentink, Nijmegen (NL)

(21) Appl. No.: 17/940,867

(22) Filed: Sep. 8, 2022

(51) Int. Cl. H04W 74/08; H04W 72/12

(52) U.S. Cl. CPC H04W 74/085; H04W 72/1263

(57) ABSTRACT

This disclosure provides systems, methods and apparatus, including computer programs encoded on computer storage media, for wireless communication, including coordinated time domain multiple access (C-TDMA) among access points (APs) with different channels. In one aspect, while using C-TDMA, a first AP may receive a control message with scheduling information for a transmission opportunity (TXOP) from a second AP, which is the TXOP owner. The second AP may operate in a certain bandwidth, and first AP may operate in an overlapping portion of the same bandwidth, and also a different portion of bandwidth. The scheduling information may indicate a portion of the TXOP for the first AP to use during the TXOP. During the portion of the TXOP for the first AP, the first AP may perform a clear channel assessment (CCA) for the overlapping and non-overlapping portions, and transmit on both the overlapping and different bandwidths during the TXOP.

### TECHNICAL FIELD

The following relates generally to wireless communication, including coordinated time domain multiple (C-TDMA) access among access points (APs) with different channels.

### DESCRIPTION OF THE RELATED TECHNOLOGY

Wireless communications systems are widely deployed to provide various types of communication content such as voice, video, packet data, messaging, broadcast, and so on. These systems may be multiple-access systems capable of supporting communication with multiple users by sharing the available system resources (such as, time, frequency, and power). A wireless network, such as a WLAN, such as a Wi-Fi (i.e., Institute of Electrical and Electronics Engineers (IEEE) 802.11) network may include AP that may communicate with one or more stations (STAs) or mobile devices. The AP may be coupled to a network, such as the Internet, and may enable a mobile device to communicate via the network (or communicate with other devices coupled to the AP). A wireless device may communicate with a network device bi-directionally. For example, in a WLAN, a STA may communicate with an associated AP via DL and UL using one or more communication links. The DL (or forward link) may refer to the communication link from the AP to the station, and the UL (or reverse link) may refer to the communication link from the station to the AP. Where the STA and associated AP are multi-link devices (MLDs), the STA may communicate with an associated AP via DL and UL using multiple different communication links, and each communication link may be DL (or forward link), or UL (or reverse link), or a combination thereof.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication at a first wireless access point (AP). The method may include receiving, from a second wireless AP operating in a second bandwidth, a first control message indicating scheduling information for at least the first wireless AP to transmit or receive packets during a transmission opportunity (TXOP), the first wireless AP operating in a first bandwidth that includes a first frequency portion that is overlapping in frequency with the second bandwidth and a second frequency portion that is different in frequency from the second bandwidth, performing, during the TXOP, a clear channel assessment (CCA) associated with at least the second frequency portion of the first bandwidth, and transmitting, in accordance with the CCA, one or more packets via the first frequency portion and the second frequency portion during at least a first portion of the TXOP granted to the first wireless AP by the scheduling information. The CCA may include detection of an ongoing transmission in the wireless medium based at least in part on energy detection, preamble detection or both.

Another innovative aspect of the subject matter described in this disclosure can be implemented in an apparatus for wireless communication at a first wireless AP. The apparatus may include a processor, memory coupled with the processor, and instructions stored in the memory. The instructions may be executable by the processor to cause the apparatus to receive, from a second wireless AP operating in a second bandwidth, a first control message indicating scheduling information for at least the first wireless AP to transmit or receive packets during a TXOP, the first wireless AP operating in a first bandwidth that includes a first frequency portion that is overlapping in frequency with the second bandwidth and a second frequency portion that is different in frequency from the second bandwidth, perform, during the TXOP, a CCA associated with at least the second frequency portion of the first bandwidth, and transmit, in accordance with the CCA, one or more packets via the first frequency portion and the second frequency portion during at least a first portion of the TXOP granted to the first wireless AP by the scheduling information.

Another innovative aspect of the subject matter described in this disclosure can be implemented in an apparatus for wireless communications at a first wireless AP. The apparatus may include means for receiving, from a second wireless AP operating in a second bandwidth, a first control message indicating scheduling information for at least the first wireless AP to transmit or receive packets during a TXOP, the first wireless AP operating in a first bandwidth that includes a first frequency portion that is overlapping in frequency with the second bandwidth and a second frequency portion that is different in frequency from the second bandwidth, means for performing, during the TXOP, a CCA associated with at least the second frequency portion of the first bandwidth, and means for transmitting, in accordance with the CCA, one or more packets via the first frequency portion and the second frequency portion during at least a first portion of the TXOP granted to the first wireless AP by the scheduling information.

Another innovative aspect of the subject matter described in this disclosure can be implemented in a non-transitory computer-readable medium storing code for wireless communication at a first wireless AP. The code may include instructions executable by a processor to receive, from a second wireless AP operating in a second bandwidth, a first control message indicating scheduling information for at least the first wireless AP to transmit or receive packets during a TXOP, the first wireless AP operating in a first bandwidth that includes a first frequency portion that is overlapping in frequency with the second bandwidth and a second frequency portion that is different in frequency from the second bandwidth, perform, during the TXOP, a CCA associated with at least the second frequency portion of the first bandwidth, and transmit, in accordance with the CCA, one or more packets via the first frequency portion and the second frequency portion during at least a first portion of the TXOP granted to the first wireless AP by the scheduling information.

Some examples of the method, apparatuses, and non-transitory computer-readable medium described herein may further include operations, features, means, or instructions for receiving a second control message prior to the first control message indicating scheduling information for a second portion of the TXOP that precedes the first portion of the TXOP.

Some examples of the method, apparatuses, and non-transitory computer-readable medium described herein may further include operations, features, means, or instructions for detecting the first frequency portion may be occupied by a transmission from the second wireless AP during the second portion of the TXOP and performing a backoff countdown of a backoff procedure for the first frequency portion during the second portion of the TXOP, where the CCA associated with the second frequency portion may be performed in the first portion of the TXOP following completion of the backoff procedure.

Some examples of the method, apparatuses, and non-transitory computer-readable medium described herein may further include operations, features, means, or instructions for pausing the backoff countdown in response to detecting a transmission from a wireless device.

Some examples of the method, apparatuses, and non-transitory computer-readable medium described herein may further include operations, features, means, or instructions for performing, during the TXOP, the CCA associated with the first frequency portion in the first portion of the TXOP following completion of the backoff procedure.

Some examples of the method, apparatuses, and non-transitory computer-readable medium described herein may further include operations, features, means, or instructions for performing a backoff countdown of a backoff procedure in the second frequency portion during the second portion of the TXOP, where the CCA associated with the second frequency portion may be performed in the first portion of the TXOP following completion of the backoff procedure and performing the CCA associated with the first frequency portion of the first bandwidth, where the one or more packets may be transmitted in accordance with the CCA associated with both the first frequency portion and the second frequency portion.

Some examples of the method, apparatuses, and non-transitory computer-readable medium described herein may further include operations, features, means, or instructions for tuning a radio of the first wireless AP to at least one subchannel of the first portion of the first bandwidth to monitor for the second control message indicating the scheduling information and tuning the radio of the first wireless AP to at least one subchannel of the second portion of the first bandwidth in response to obtaining the scheduling information.

In some examples of the method, apparatuses, and non-transitory computer-readable medium described herein, performing the CCA may include operations, features, means, or instructions for performing the CCA associated with the second frequency portion during an inter-frame spacing window of the first portion of the TXOP.

In some examples of the method, apparatuses, and non-transitory computer-readable medium described herein, performing the CCA may include operations, features, means, or instructions for performing the CCA associated with the second frequency portion during the first portion of the TXOP regardless of whether a backoff countdown for the first wireless AP may have completed.

Some examples of the method, apparatuses, and non-transitory computer-readable medium described herein may further include operations, features, means, or instructions for selecting a length, a frequency or both, of the one or more packets to transmit to a first wireless station (STA) in accordance with a threshold count, a threshold duration, or both, for one or more packets to be received from the first wireless STA.

Some examples of the method, apparatuses, and non-transitory computer-readable medium described herein may further include operations, features, means, or instructions for transmitting, to a second STA, an indication of a grant of a sub-portion of the first portion of the TXOP granted to the first wireless AP by the scheduling information, where the second STA performs a CCA prior to transmitting during the sub-portion.

Some examples of the method, apparatuses, and non-transitory computer-readable medium described herein may further include operations, features, means, or instructions for performing the CCA associated with the first frequency portion of the first bandwidth using a first radio of the first wireless AP, where the CCA associated with the second frequency portion of the first bandwidth may be performing using a second radio of the first wireless AP.

In some examples of the method, apparatuses, and non-transitory computer-readable medium described herein, the CCA associated with the second frequency portion of the first bandwidth may be performed following completion of a backoff procedure associated with the second radio.

In some examples of the method, apparatuses, and non-transitory computer-readable medium described herein, the first wireless AP may be of a first basic service set (BSS) and the second wireless AP may be of a second BSS.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows an example wireless communications system that supports coordinated time domain multiple access (C-TDMA) among access points (APs) with different channels.

FIG. 2 shows an example timing diagram illustrating an example of the transmissions of communications that support C-TDMA among APs with different channels.

FIG. 3A shows an example frequency resource allocation that supports C-TDMA among APs with different channels.

FIG. 3B shows an example frequency resource allocation that supports C-TDMA among APs with different channels.

FIG. 3C shows an example frequency resource allocation that supports C-TDMA among APs with different channels.

FIG. 4 shows a timing diagram illustrating an example of communications that support C-TDMA among APs with different channels.

FIG. 5 shows a timing diagram illustrating an example of communications that support C-TDMA among APs with different channels.

FIG. 6 shows an example diagram of a system that supports C-TDMA among APs with different channels.

FIG. 7 shows a flowchart showing example methods that support C-TDMA among APs with different channels.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Coordinated time domain multiple access (C-TDMA) may allow a group of access points (APs) to share or participate in a single transmission opportunity (TXOP) within a bandwidth. In C-TDMA, a first AP may secure a TXOP for a bandwidth and share the TXOP with other APs. The APs sharing the TXOP may take turns communicating during respective portions of the TXOP according to scheduling information provided by the first AP. Some of the APs sharing the TXOP may operate on overlapping, but different, frequencies and bandwidths. For example, the first AP that owns the TXOP may operate on a bandwidth having a number of channels (which also may be referred to as subchannels, such as the subchannels defined in IEEE 802.11). A second AP may operate on some of the same channels as the first AP, but also may operate on one or more other channels that do not overlap with the operating bandwidth of the first AP. According to current approaches, C-TDMA allows the first AP to share a portion of the bandwidth with the second AP that corresponds to channels shared between the first AP and the second AP. This restriction may prevent the second AP from transmitting or receiving over its full operating bandwidth. Consequently, the throughput of the second AP may be reduced during the shared TXOP.

To avoid this reduction in throughput, the second AP may perform a clear channel assessment (CCA) for its respective portion of the shared TXOP. The second AP may perform the CCA for an entirety of its operating bandwidth, including the channels shared with the first AP and the channels that are outside the operating bandwidth of the first AP. If the CCA indicates the medium is clear for transmission during the shared TXOP, the second AP may be free to transmit or receive on any portion (such as any channel or combination of channels) of its operating bandwidth during the scheduled TXOP in accordance with the scheduling information from the first AP. The second AP may thus use its full bandwidth for communication with STAs of its BSS during the scheduled portion of the shared TXOP. In some implementations, the second AP may sub-grant a portion of the TXOP to other wireless devices, such as other APs or STAs.

Particular implementations of the subject matter described in this disclosure can be implemented to realize one or more of the following potential advantages. In some implementations, the described techniques may increase network throughput by permitting a scheduling AP (such as the first AP) to share a TXOP with other APs (such as the second AP) that may have nonoverlapping bandwidth, thus allowing the other APs to use additional frequency resources beyond the bandwidth of the scheduling AP. As such, the other APs may not have to perform conventional carrier sense multiple access/collision avoidance (CSMA/CA) or enhanced distributed channel access (EDCA) techniques to transmit and receive data in the overlapping and nonoverlapping bandwidth during the TXOP. Additionally, by allowing the other APs to sub-grant a portion of the TXOP to third wireless devices, such as other APs or STAs, some implementations may allow for increased uplink or downlink throughput and improved efficiency in the utilization of finite time and frequency resources. Various implementations may achieve these and other potential advantages without requiring any of the APs to be aware of the STAs associated with other BSSs (OBSSs), without requiring a preassigned or dedicated master AP or preassigned groups of APs, or without requiring backhaul coordination between the APs participating in the TXOP.

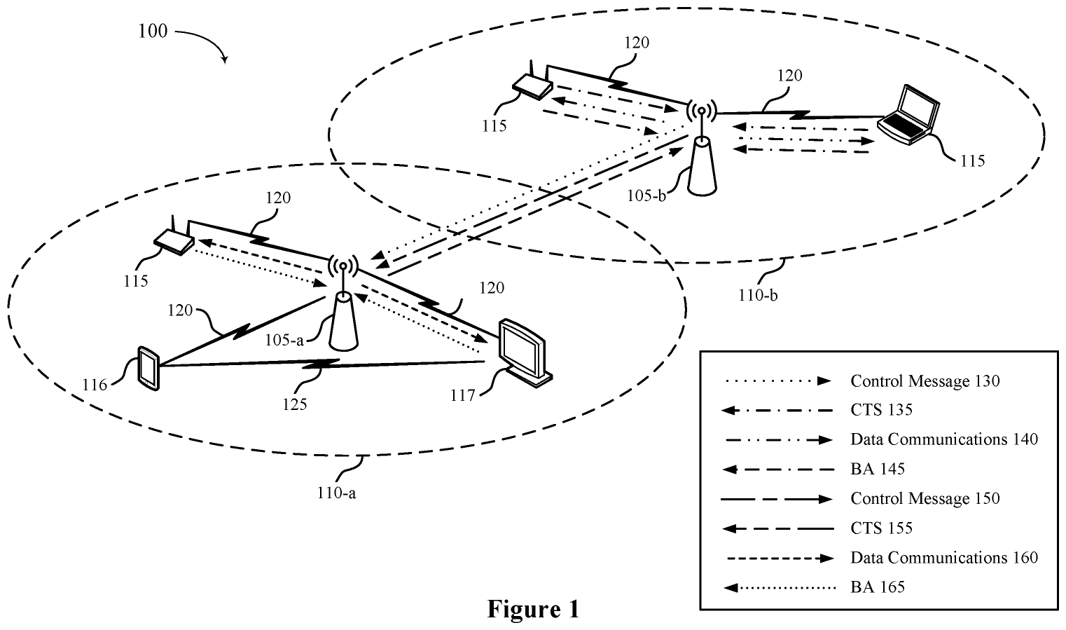

FIG. 1 shows an example wireless communications system 100 that supports high frequency multi-link support systems operation. The wireless communications system 100 may be an example of a wireless local area network (WLAN) or a Wi-Fi network and may include an AP 105 and multiple associated STAs 115, which may represent devices such as mobile stations, personal digital assistant (PDAs), other handheld devices, netbooks, notebook computers, tablet computers, laptops, display devices (such as TVs or computer monitors), or printers. The AP 105 and the associated STAs 115 may represent a basic service set (BSS) or an extended service set (ESS). The various STAs 115 in the network are able to communicate with one another through the AP 105. Also shown is a coverage area 110-a of the AP 105-a and a coverage area 110-b of the AP 105-b, each of which may represent a BSA of the wireless communications system 100. An extended network station (not shown) associated with the wireless communications system 100 may be connected to a wired or wireless distribution system that may allow multiple APs 105 to be connected in an ESS.

A STA 115 may be located in the intersection of more than one coverage area 110 and may associate with more than one AP 105. A single AP 105 and an associated set of STAs 115 may be referred to as a BSS. An ESS is a set of connected BSSs. A distribution system (not shown) may be used to connect APs 105 in an ESS. In some implementations, the coverage area 110 of an AP 105 may be divided into sectors (also not shown). The wireless communications system 100 may include APs 105 of different types (such as metropolitan area, or home network), with varying and overlapping coverage areas 110. Two STAs 115 also may communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and medium access control (MAC) layers from IEEE 802.11 and versions including, but not limited to, 802.11b, 802.11g, 802.11a, 802.11n, 802.11ac, 802.11ad, 802.11ah, 802.11ax, or 802.11be. In some other implementations, peer-to-peer (P2P) connections or ad hoc networks may be implemented within wireless communications system 100.

In some implementations, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment, such as a carrier-sense multiple access with collision avoidance (CSMA/CA) environment, because the STAs 115 may transmit at the same time. A STA 115 whose transmissions are not identifiable, but that is within the same coverage area 110 may be known as a hidden node. CSMA/CA may be supplemented by the exchange of a request to send (RTS) packet transmitted by a sending STA 115 (or AP 105) and a clear to send (CTS) packet transmitted by the receiving STA 115 (or AP 105). This may alert other devices within range of the sender and receiver not to transmit for the duration of the primary transmission. Thus, RTS/CTS may help mitigate a hidden node problem.

The AP 105-b of the wireless communications system 100 may win contention to gain access to a wireless medium for a duration of a TXOP. In such implementations, the AP 105-b may be referred to as the TXOP owner AP. According to C-TDMA techniques, the AP 105-b that wins contention and gains access to the wireless medium for the duration of a TXOP may share time resources with other APs 105-a, which also may be referred to as participant APs or coordinated APs. The AP 105-b also may be referred to as a TXOP owner AP or scheduling AP. The AP 105-b may partition the TXOP into multiple TXOP segments or portions, each TXOP portion including respective time resources representing a sub-duration of the TXOP. For example, the AP 105-b may assign, grant, or allocate, hereinafter used interchangeably, one or more of the time resources to the AP 105-b and also allocate each of one or more remaining time resources to one or more other participant APs, including the APs 105-a. In some implementations, the AP 105-b shares all frequency resources with one or more participant APs, including the AP 105-a, that have been allocated time resources in a portion of the TXOP. In some other implementations, the AP 105-b may allocate different portions of the bandwidth to at least some of the participant APs, including APs 105-a.

The AP 105-a and STAs associated with the AP 105-b in coverage area 110-b may receive a control message 130, such as an MU-RTS, from the AP 105-b that indicates scheduling information for the TXOP owned by the AP 105-b. The STAs 115 associated with the AP 105-b in coverage area 110-b that receive the control message 130 may each respond with a CTS 135. In some implementations, the AP 105-a also may respond to the control message 130 with a CTS. After receiving the CTS 135 the AP 105-b may transmit or receive, via downlink (DL) transmission, uplink (UL) reception, or both, the data communications 140 with the STAs 115 in coverage area 110-b within the TXOP. The STAs 115 successfully receiving via DL the data communications 140 may transmit acknowledgements to AP 105-b, for example using a block acknowledgement (BA) 145.

The AP 105-a may operate in at least a portion of the bandwidth scheduled by the AP 105-b within the TXOP. For example, an operating bandwidth of the AP 105-a may include an overlapping portion that overlaps in frequency with the bandwidth scheduled by the AP 105-b within the TXOP, and also a nonoverlapping portion that is different in frequency from the bandwidth scheduled by the AP 105-b within the TXOP. The scheduling information of the control message 130 (RTS or another control message) may indicate a first portion of the TXOP granted or scheduled for the AP 105-a to use during the TXOP. This first portion of the TXOP may fall within the overlapping portion of the operating bandwidth of the AP 105-a. Additionally, or alternatively, the AP 105-a may transmit scheduling information for the TXOP owned by the AP 105-b. The scheduling information may identify the portion of the TXOP for the AP 105-a, at or prior to the start of the TXOP portion for the AP 105-a. For example, the scheduling information may be included in a control message 150 (such as an MU-RTS or another control message).

During the first portion of the TXOP for AP 105-a, the AP 105-a may perform a CCA for the overlapping portion of the bandwidth, and also for the nonoverlapping portion of the bandwidth. If the CCA indicates the medium is clear for transmission for the first TXOP portion, the AP 105-a may transmit on the nonoverlapping bandwidth, as well as on the overlapping bandwidth. The AP 105-b may poll the AP 105-a or trigger the AP 105-a to operate in the first TXOP portion, for example using the control message 150. In response to the control message 150, the AP 105-a may transmit a CTS 155. The AP 105-a may proceed to transmit via DL, receive via UL, or both, the data communications 160 with the STAs 115 associated with AP 105-a within the coverage area 110-a. STAs 115 that successfully receive the data communications 160 via DL transmission may acknowledge receipt by transmitting acknowledgements to the AP 105-a, for example using a BA 165.

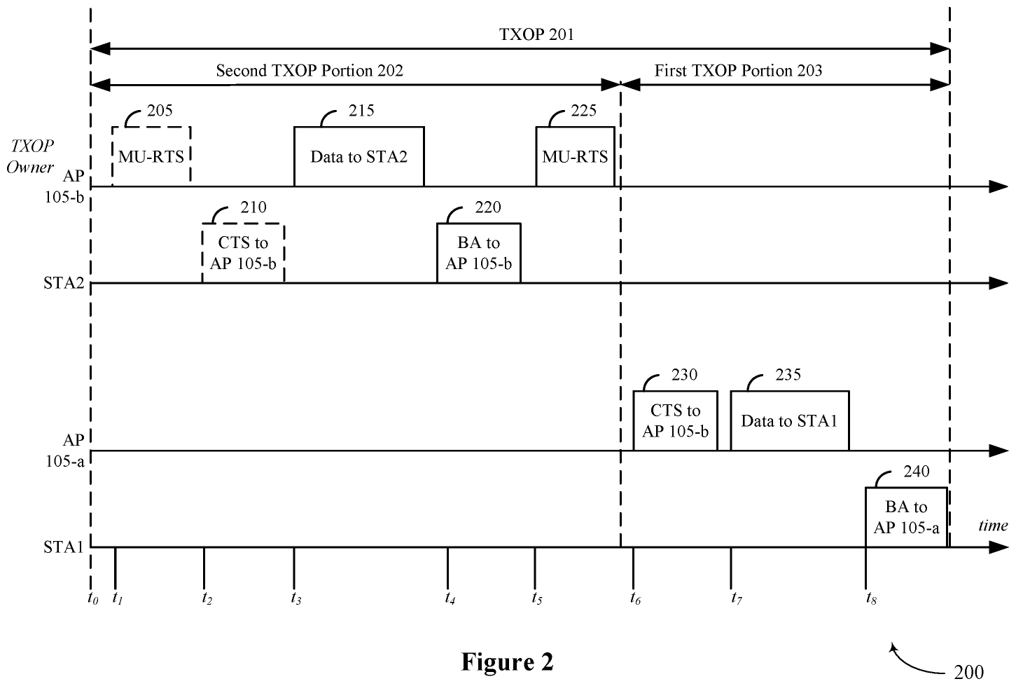

FIG. 2 shows an example timing diagram 200 illustrating an example of the transmissions of communications that support C-TDMA among APs with different channels. AP 105-a may be an example of the AP 105-a of FIG. 1. AP 105-b may be an example of the AP 105-b of FIG. 1. STA1 may be an example of a STA 115 of FIG. 1 associated with the AP 105-a. STA2 may be an example of a STA 115 of FIG. 1 associated with the AP 105-b.

In some implementations, STA1 and zero or more additional STAs may be associated with a first BSS of AP 105-a. STA2 and zero or more additional STAs may be associated with a second BSS of AP 105-b.

In the example of timing diagram 200, the TXOP owner (AP 105-b) may obtain a TXOP 201 and shares it with one or more other coordinated APs (AP 105-a, and optionally one or more additional APs). As further illustrated, the TXOP 201 includes multiple portions, phases, or stages including, a first TXOP portion 203 and a second TXOP portion 202.

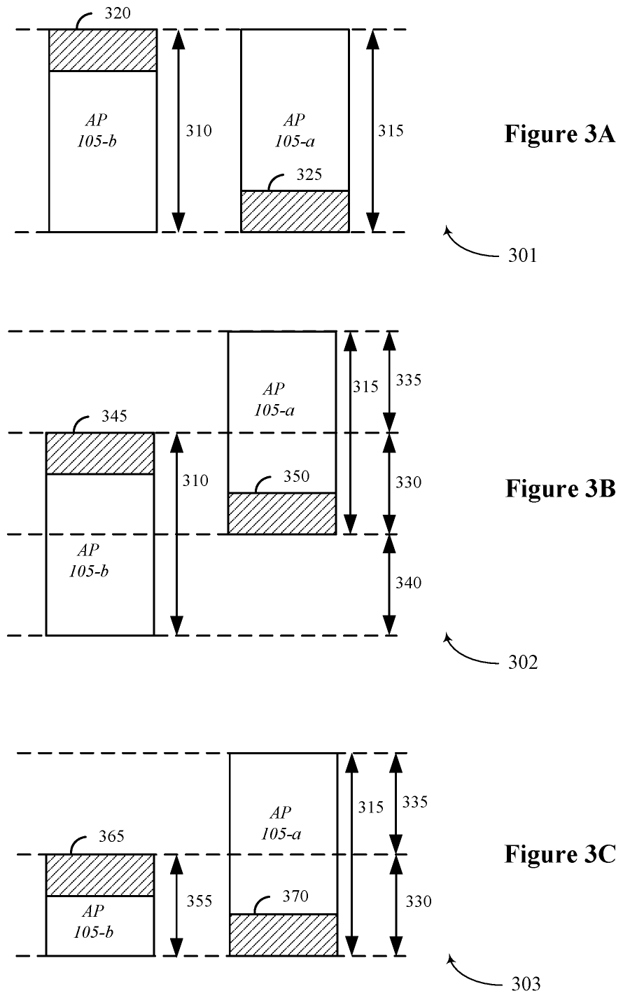

The operating bandwidth of the AP 105-a (a first bandwidth) may be different than the operating bandwidth of the TXOP owner AP 105-b (a second bandwidth), for example with reference to FIG. 3A, FIG. 3B, and FIG. 3C. In one example, the first bandwidth may be a subset of the second bandwidth. In another example, the first bandwidth may include a first frequency portion that is a subset of the second bandwidth and a second frequency portion that is outside the first bandwidth. In yet another example, the first bandwidth may include all of the second bandwidth (the first frequency portion), and an additional second frequency portion that is outside the first bandwidth. The first bandwidth may be contiguous or non-contiguous in frequency. Similarly, the second bandwidth may be contiguous or non-contiguous in frequency. In some implementations, the first bandwidth also may be the same as the second bandwidth and they fully overlap in frequency. In this case, AP 105-a and AP 105-b may have the same or different primary channels in frequency. Although the examples illustrate TXOP sharing between APs, the techniques discussed also may be applicable to a scenario in which an AP 105-b allocates a portion of a TXOP that the AP 105-b has obtained to a first device associated with the AP 105-b for data exchange between the first device and a second device (such as over a peer-to-peer link between the first device and the second device).

In some implementations, to obtain the TXOP 201, the TXOP owner AP 105-b contends for access to the wireless medium on one or more channels of the second bandwidth, including a primary operating channel or primary channel, which also may be referred to as a subchannel, for example when a bandwidth includes multiple subchannels. For example, the second bandwidth may be a wideband wireless channel for AP 105-b and may be 20 MHz, 40 MHz, 80 MHz, 160 MHz, 320 MHz, or more, and may include a primary 20 MHz channel and one or more secondary channels. The secondary channels may be 20 MHz, 40 MHz, 80 MHz, or 160 MHz channels) using, for example, CSMA/CA and enhanced distributed channel access (EDCA) techniques. The TXOP 201 may be obtained at time t₁ for a wideband wireless channel, such as a bonded channel formed by the primary channel and the zero or more secondary channels.

In some implementations, after obtaining the TXOP 201, and to ensure interference-free communications during the TXOP 201, the TXOP owner AP 105-b may further reserve the wireless channel by transmitting a multi-user request-to-send (MU-RTS) frame 205 to one or more STAs associated with AP 105-b, and one or more APs, including AP 105-a. In some implementations, the MU-RTS frame 205 also may be a control message that is configured to be received by one or more other APs, for example APs of an ESS. The MU-RTS frame 205 may be configured to cause at least one of the STAs to transmit a clear-to-send (CTS) frame 210. Any other wireless communication devices, including the AP 105-a, and their associated STAs, that receive either or both of the MU-RTS frame 205 or CTS frame 210 may set their respective network allocation vectors (NAVs) for a duration of time indicated in the MU-RTS frame 205 or the CTS frame 210.

In some implementations, to select the one or more other coordinated APs to participate in the TXOP 201, the TXOP owner AP 105-b optionally may perform a TXOP availability indication process, for example during a TXOP indication phase during which the TXOP owner AP 105-b learns of the other APs' desire or intent to participate in the TXOP 201. The TXOP indication phase may conclude prior to the transmission of the MU-RTS frame 205 at time t₁. In some implementations, the TXOP indication phase may begin at or following time t₁, when the TXOP 201 is obtained. In other examples, the TXOP indication phase may occur prior to when the TXOP 201 is obtained such as time to. In some implementations, during the TXOP indication phase, the AP 105-a may advertise an availability of time resources in the TXOP 201. The TXOP owner AP 105-b may previously have become aware of the other neighboring APs in the vicinity of AP 105-b based on information in beacons, other management frames, or other control frames received from the other APs. The TXOP owner AP 105-b may proceed to select one or more of the candidate APs, including AP 105-a, to participate in the TXOP 201.

Additionally, or alternatively, in some implementations, the TXOP owner AP 105-b may already be aware of another AP's desire or willingness to participate in TXOPs owned (or that will be owned in the future) by AP 105-a at the time AP 105-a obtains the current TXOP 201. For example, the TXOP owner AP 105-b may determine that the other AP would participate in the current TXOP 201 based on a previous performance of a TXOP indication process in a TXOP indication phase of a previous TXOP or via out-of-band signaling such as signaling over a backhaul. In some such implementations, the TXOP owner AP 105-b may select the candidate APs to participate in the TXOP 201 before or after obtaining the TXOP 201.

The TXOP owner AP 105-b may determine an amount of time resources of the TXOP to allocate to each of the selected APs after selecting the APs. In some implementations, the TXOP owner AP 105-b divides the available time resources of the TXOP 201 into two or more TXOP portions, each including one or more time resources. For example, the TXOP owner AP 105-b may partition the TXOP 201 into two portions, which may be equal or unequal, such as a first TXOP portion 203 for AP 105-a and a second TXOP portion 202 for the TXOP owner AP 105-b. The first TXOP portion 203 may follow the second TXOP portion 202 in time.

After selecting the APs to participate in the TXOP 201 the TXOP owner AP 105-b grants, schedules or otherwise actually allocates (such as, indicates the allocations of) the respective time resources to the selected APs. In some implementations, the selection of the AP 105-a or the amount of time resources allocated to the AP 105-a by the AP 105-b may be indicated in a control message as illustrated by the MU-RTS frame 205 in FIG. 2. In some other implementations, the AP 105-b may skip the MU-RTS frame 205 and the following CTS frame 210 at the beginning of the TXOP 201. In this case, the selection of AP 105-a or the amount of time resources allocated to AP 105-a may be indicated in another control message as illustrated by the MU-RTS frame 225, proceeding a first TXOP portion 203 that is allocated to AP 105-a. For example, following the TXOP indication process, and prior to time t₁, the TXOP owner AP 105-b may transmit the MU-RTS frame 205 that includes, for each of the selected APs, TXOP scheduling information including an indication of the TXOP portions allocated to the respective APs, including the first TXOP portion 203 for AP 105-a and a second TXOP portion 202 for the TXOP owner AP 105-b. The first TXOP portion 203 may be indicated as time resources usable by the respective AP 105-a to transmit data to, or receive data from, one or more respective associated wireless STAs. The second TXOP portion 202 may be indicated in the third frame as time resources usable by AP 105-b to transmit data to, or receive data from, one or more respective associated wireless STAs.

The TXOP owner AP 105-b may transmit the MU-RTS frame 205 or the MU-RTS frame 225 in a non-high-throughput duplicate PPDU that indicates the time resources of the first TXOP portion 203 allocated to AP 105-a in each of multiple channels of an operating bandwidth for AP 105-b (such as, in each of multiple 20 MHz subchannels). In this way, the other APs do not need to be operating on the same primary 20 MHz channel to receive and process the MU-RTS frame 205 or the MU-RTS frame 225. In some implementations, a source address field and a BSSID field (such as, in a MAC header) associated with the MU-RTS frame 205 are set to the MAC address of the TXOP owner and a destination address field (such as, in the MAC header) associated with the MU-RTS frame 205 is set to a broadcast address.

Each duplicate copy of the MU-RTS frame 205 or of the MU-RTS frame 225 in the non-HT duplicate PPDU may include, for each of the selected APs, an indication of the TXOP portion allocated to the respective AP. For example, each copy of the MU-RTS frame 205 on a 20 MHz subchannel may include a user information field for each of the selected APs. Each user information field may include a respective APID of a respective AP. For example, the APID may be a MAC address of the AP, a BSSID associated with the AP, a BSS color associated with the AP, or a short identifier associated with the AP. Each user information field may include, for the respective AP, an indication of a starting time, a time duration, or both, of the respective allocated time resources. For example, the user information field may include an indication of a symbol, a slot or an absolute or relative time at which the allocated time resources begin for AP 105-a, identifying the first TXOP portion 203, and an indication of a symbol, a slot or an absolute or relative time at which the allocated time resources begin for AP 105-b, identifying the second TXOP portion 202. Additional indications may be provided in the user information for additional respective APs. The user information field also may include a duration of the respective allocated time resources, for example, in units of symbols, slots, or milliseconds (ms). The duration may be indicated with reference to the MU-RTS frame 205 or the MU-RTS frame 225, or with reference to a timer synchronized across the APs, including AP 105-a and AP 105-b, such as a timing synchronization function (TSF) timer. In some implementations, the user information field may indicate the time duration of allocated to a participant AP within the TXOP 201 obtained by the AP 105-b. For example, the time duration of the first TXOP portion 203 may be indicated in the user information field associated with AP 105-a. The time duration of the first TXOP portion 203 may be indicated in the MU-RTS 205, the MU-RTS 225, or both. Each user information field may further include, for the respective selected AP, an indication of frequency resources available for use by the respective AP while using the respective allocated time resources. For example, the user information field may indicate one or more channels or subchannels (such as, one or more or 20 MHz channels) or one more resource units (RUs) or sets of RUs usable by the respective AP while using the allocated time resources. In some implementations or instances, the TXOP owner AP 105-b and one or more of other APs, including AP 105-a may be configured for communication via C-TDMA as well as CAP OFDMA simultaneously. In other implementations or instances, the MU-RTS frame 205 may allocate all of the available frequency resources to each of the selected APs for use while using their respective allocated time resources. The MU-RTS frame 205 or the MU-RTS frame 225 also may include the operating bandwidth information (which also may be referred to as operating channel information) of the TXOP owner AP 105-b, such as an indication of the center frequency and the system bandwidth, so that the respective selected APs can unambiguously derive the frequency resources or spatial resources to be used in the data transmission phase.

After schedule allocation via the MU-RTS frame 205, at t₃ the TXOP owner AP 105-b may proceed to perform data communications 215 with their respective STAs, including STA2. Data communications 215 may include performing DL communications, enabling UL communications, or both DL and UL. The APs capable of C-TDMA, including AP 105-a and AP 105-b, may be configured to transmit and receive data communications, acknowledgement (ACK) frames, and trigger frames regardless of their respective NAVs during their allocated time resources.

Additionally, the STAs compatible with C-TDMA may be configured to be in an active listening mode at least during the respective allocated time resources and such that they may transmit and receive data communications, ACK frames, and trigger frames regardless of their respective NAVs. For example, for the data communications 215, the TXOP owner AP 105-b may transmit or receive one or more data communications to or from one or more STAs in the BSS of the TXOP owner AP 105-b beginning at time t₃ using the time resources allocated to itself and the BSS during the second TXOP portion 202. The data communications 215 may begin a SIFS duration after the reception of the CTS frame 210. In some implementations, the TXOP owner AP 105-b may transmit using multi-user (MU) orthogonal frequency division multiple access (OFDMA). Additionally, or alternatively, the TXOP owner AP 105-b may transmit a data frame to multiple STAs using MU multiple-input multiple-output (MIMO). Additionally, or alternatively, the TXOP owner AP 105-b may transmit a data frame using single-user (SU) techniques.

In some such implementations in which the TXOP owner AP 105-b transmits one or more DL data communications, the associated STAs may respond with the ACK frames 220, such as Block ACKs (BAs), also using one or more of the time resources allocated to the TXOP owner AP 105-b and the BSS of AP 105-b in the first TXOP portion 203. As such, the first TXOP portion 203 allocated to the TXOP owner AP 105-b include not only time resources for transmitting DL communications, but also enough time resources for the associated STAs to transmit the ACK frames 220, which may be transmitted a SIFS duration after receipt of the DL communications.

In addition to, or as an alternative to, transmitting DL data communications, the TXOP owner AP 105-b also may receive one or more UL data communications from one or more STAs in the BSS of AP 105-b in the first TXOP portion 203. For example, the TXOP owner AP 105-b may transmit a trigger frame during the first TXOP portion 203 that triggers an UL data communication including multiple data frames from multiple STAs using one or more of MU OFDMA or MU MIMO in the form of a MU PPDU, or an UL data communication from each of one or more single STAs sequentially in the form of respective SU PPDUs. In some such implementations in which the TXOP owner AP 105-b receives one or more UL data communications, the TXOP owner AP 105-b may respond with ACK frames (such as BAs) also using one or more of the time resources allocated to the TXOP owner AP 105-b and the BSS of AP 105-b in the first TXOP portion 203. As such, the first TXOP portion 203 allocated to the TXOP owner AP 105-b include not only time resources for transmitting trigger frames and receiving UL communications, but also time resources for transmitting the ACK frames 220, which may be transmitted a SIFS duration after receipt of the UL communications.

In some implementations, prior to transmitting any communications the AP 105-a may perform a CCA (which also may be referred to as a CCA operation) on one or more (or all) of the subchannels of the first bandwidth associated with AP 105-a. For example, in some implementations, the TXOP owner AP 105-a may perform physical carrier sensing, and specifically energy detection, to determine whether the wireless medium is idle prior to transmitting any data, trigger, management or control frames in the first TXOP portion 203. If the AP 105-a senses that the wireless medium is not idle, AP 105-a may forgo transmitting any communications in the time resources allocated to AP 105-a. Additionally to CCA, or alternatively to CCA, AP 105-a may perform packet detection on one or more, or all, of the channels of the first bandwidth of AP 105-a.

Similar to the TXOP owner AP 105-b, the first AP 105-a may transmit or receive one or more data communications to or from one or more STAs in the BSS of AP 105-a using time resources during a first TXOP portion 203 allocated to the first AP 105-a by AP 105-b. The STAs may be configured to be in an active listening mode at least during the first TXOP portion 203, and such that they may transmit and receive data communications, ACK frames, and trigger frames regardless of their respective NAVs. In some implementations, there may be a guard (or “non-transmission”) interval (such as, for a SIFS duration) between the time resources allocated to a given one of the APs, such as the second TXOP portion 202, and the adjacent time resources allocated to another one of the APs, such as the first TXOP portion 203, to buffer and guard against interference that may result from overlapping communications that may result from timing errors.

At time t₅, AP 105-b may transmit an indication of a poll to start AP 105-a to use the time resources allocated to AP 105-a. In some implementations, the time resources allocated to AP 105-a, such as a time duration illustrated by the first TXOP portion 203, may be indicated in the MU-RTS frame 225 by itself (such as in the case the AP 105-b does not transmit the MU-RTS frame 205 in the beginning of the TXOP to indicate the allocation up front). The indication of the poll may be provided in a user information field identifying an APID associated with the AP 105-a in the MU-RTS frame 225. Additionally, or alternatively, the AP 105-b may transmit an indication of scheduling information for the TXOP owned by the AP 105-b, and in particular identifying first TXOP portion 203, at or prior to the start of the TXOP portion for the AP 105-a. For example, the AP 105-b may include this scheduling information in the MU-RTS frame 205. The first TXOP portion 203 may be identified by an APID associated with AP 105-a and a duration for the TXOP portion 203. In this case, the MU-RTS frame 225 may simply refer to the time resources already indicated in the MU-RTS frame 205 or carry another indicate the time resources allocated to AP 105-a.

In response to the MU-RTS frame 225, the AP 105-a may transmit at time t₆ a CTS 230 to the AP 105-b to confirm reception of MU-RTS frame 205. The CTS 230 also may be received by other wireless communication devices to confirm that the AP 105-b is going to use first TXOP portion 203 for data communications. The other wireless communications devices may include STAs within the BSS of the AP 105-a, including STA1, other APs sharing the TXOP 201, or other APs including the AP 105-b.

After transmitting the CTS 230, the AP 105-a may proceed at time t₇ to perform the data communications 235 with the respective STAs in the BSS of the AP 105-a, including STA1. The data communications 235 may begin a SIFS duration after the transmission of the CTS 230. The data communications 235 may include performing downlink (DL) communications, enabling uplink (UL) communications, or both DL and UL. In some implementations, the AP 105-a may transmit using MU OFDMA. Additionally, or alternatively, the AP 105-a may transmit a data frame to multiple STAs using MU MIMO. Additionally, or alternatively, the AP 105-a may transmit a data frame using SU techniques.

The operating bandwidth of the AP 105-a (the first bandwidth) may be different than the operating bandwidth of the TXOP owner AP 105-b (the second bandwidth), for example with reference to FIG. 3A, FIG. 3B, and FIG. 3C. In one example, the first bandwidth may be a subset of the second bandwidth. In another example, the first bandwidth may include a first frequency portion that is a subset of the second bandwidth and a second frequency portion that is outside the first bandwidth. In yet another example, the first bandwidth may include all of the second bandwidth (the first frequency portion), and an additional second frequency portion that is outside the first bandwidth. The first bandwidth may be contiguous or non-contiguous in frequency. Similarly, the second bandwidth may be contiguous or non-contiguous in frequency. Although not shown in FIG. 3, in some implementations the first bandwidth also may be the same as, and fully overlap in frequency with the second bandwidth. In such implementations, the AP 105-a and the AP 105-b may have the same or different primary channels in frequency.

Also similar to the TXOP owner AP 105-b, prior to transmitting communications to any of their associated STAs, AP 105-a may perform CCA at a beginning of the first TXOP portion 203. The AP 105-a may perform physical carrier sensing, and specifically energy detection, to determine whether the wireless medium is idle on one or more, or all, of the subchannels of the first bandwidth prior to transmitting any data, trigger, management or control frames during time resources allocated to the AP 105-a, as described above with reference to the TXOP owner AP 105-b. Additionally to CCA, or alternatively to CCA, AP 105-a may perform packet detection on one or more, or all, of the channels of the first bandwidth of AP 105-a.

Consistent with the techniques described herein, the AP 105-a, may have received scheduling information in the MU-RTS frame 205 for the TXOP 201, and specifically for the first TXOP portion 203. In examples where the first bandwidth of the AP 105-a includes a first frequency portion that overlaps with the second bandwidth for the TXOP owner AP 105-b, and the first bandwidth additional including a second frequency portion that is different from (outside, non-overlapping with) the first bandwidth, the AP 105-a may transmit on the second frequency portion during the TXOP 201. For example, the AP 105-a may proceed to start transmitting on the one or more 20 MHz channels of the first frequency portion (the overlapping portion) following a PIFS or SIFS delay after transmitting CTS 230.

For the second frequency portion (the different, non-overlapping portion) AP 105-a may perform CCA. AP 105-a may not need to perform the backoff procedure in the overlapping, first frequency portion, for example because that portion is included within the time and frequency resources scheduled by the TXOP owner AP 105-b. However, AP may need to perform CCA for the first frequency portion, for example depending on a region or sequence.

If the CCA indicates that the second frequency portion is clear, AP 105-a may proceed to perform the data communications 235 with respective STAs of the BSS of AP 105-a, including STA1, using the non-overlapping second frequency portion in addition to the first frequency portion during the second TXOP portion 202. The data communications 235 may include performing downlink (DL) communications, enabling uplink (UL) communications, or both DL and UL. In some implementations, AP 105-a may transmit using MU OFDMA. Additionally, or alternatively, the AP 105-a may transmit a data frame to multiple STAs using MU MIMO. Additionally, or alternatively, the AP 105-a may transmit a data frame using SU techniques. Resources, such as resource units, allocated for data communications 235 may span the first bandwidth, including both the first frequency portion and the second frequency portion.

In some such implementations in which the AP 105-a transmits one or more DL data communications, the associated STAs may respond at time t₈ with the ACK frames 240, such as BAs, also using one or more of the time resources allocated to the AP 105-a during first TXOP portion 203 and the BSS of AP 105-a in the first TXOP portion 203. As such, the first TXOP portion 203 allocated to the AP 105-a include not only time resources for transmitting DL, UL, or both, communications, but also enough time resources for the associated STAs to transmit the ACK frames 240 (such as a BA), which may be transmitted a SIFS duration after receipt of the DL communications. Although this example shows that the device is the AP 105-a exchanging data and ACK frames with an associated device, the same method may be used even if device is a non-AP device, associated with the AP 105-b, that exchanges data and ACK frames with another device via a peer-to-peer link during the first TXOP portion 203 allocated by the AP 105-b. For example, the peer-to-peer link may be established by a peer-to-peer protocol such as tunneled direction link setup (TDLS) and soft AP.

FIG. 3A, FIG. 3B, and FIG. 3C show example frequency resource allocations 301, 302, and 303, respectively, that support C-TDMA among APs with different channels. AP 105-a may be an example of a participant AP in a shared TXOP, for example the AP 105-a of FIG. 1 or an AP 105-a of FIG. 2. AP 105-b may be an example of a TXOP owner AP in a shared TXOP, for example the AP 105-b of FIG. 1 or an AP 105-b of FIG. 2.

With reference to FIG. 3A, frequency resource allocation 301 may include a first bandwidth 315 of AP 105-a, including a primary channel 325. For example, the first bandwidth 315 may be a wideband wireless channel and may be 20 MHz, 40 MHz, 80 MHz, 160 MHz, 320 MHz, or more, that includes a primary channel 325 and one or more secondary channels. The primary channel 325 may be a 20 MHz channel. In other examples, the primary channel may be a 40 MHz, 80 MHz, or 160 MHz channel. The secondary channels may be 20 MHz, 40 MHz, 80 MHz, or 160 MHz channels.

The primary channel of an AP, including the primary channel 320 and the primary channel 325, may be used by the respective AP 105-b and the AP 105-a to monitor for incoming packets.

Frequency resource allocation 301 also may include a second bandwidth 310 of AP 105-b, including the primary channel 325. For example, the second bandwidth 310 may be a wideband wireless channel and may be 20 MHz, 40 MHz, 80 MHz, 160 MHz, 320 MHz, or more, that includes the primary channel 320 and one or more secondary channels. The primary channel 325 may be a 20 MHz channel. In other examples, the primary channel may be a 40 MHz, 80 MHz, or 160 MHz channel. The secondary channels may be 20 MHz, 40 MHz, 80 MHz, or 160 MHz channels.

Frequency resource allocation 301 illustrates an example frequency resource allocation where the first bandwidth 315 and the second bandwidth 310 are a same bandwidth and fully overlap, such that there are no non-overlapping frequency portions. In some implementations, the primary channel 320 and the primary channel 325 may be a same channel, and occupy a same set of frequency resources. In other examples, the primary channel 320 and the primary channel 325 may be different channels, occupying different sets of frequency resources. The different sets of frequency resources may be fully different in some examples, or may be partially overlapping.

The first bandwidth 315 and the second bandwidth 310 may each use a resource unit (RU) allocation that is the same or different, even if the first bandwidth 315 and the second bandwidth 310 are the same bandwidth and share frequency resources.

With reference to FIG. 3B, frequency resource allocation 302 may include a first bandwidth 315 of AP 105-a, including a primary channel 350. For example, the first bandwidth 315 may be a wideband wireless channel and may be 20 MHz, 40 MHz, 80 MHz, 160 MHz, 320 MHz, or more, that includes the primary channel 350 and one or more secondary channels. The primary channel 350 may be a 20 MHz channel. In other examples, the primary channel may be a 40 MHz, 80 MHz, or 160 MHz channel. The secondary channels may be 20 MHz, 40 MHz, 80 MHz, or 160 MHz channels.

Frequency resource allocation 302 also may include a second bandwidth 310 of AP 105-b, including a primary channel 345. For example, the second bandwidth 310 may be a wideband wireless channel and may be 20 MHz, 40 MHz, 80 MHz, 160 MHz, 320 MHz, or more, that includes primary channel 345 and one or more secondary channels. The primary channel 345 may be a 20 MHz channel. In other examples, the primary channel may be a 40 MHz, 80 MHz, or 160 MHz channel. The secondary channels may be 20 MHz, 40 MHz, 80 MHz, or 160 MHz channels.

Frequency resource allocation 302 illustrates an example frequency resource allocation where the first bandwidth 315 and the second bandwidth 310 at least partially overlap, such that there is a first frequency portion 330 that is overlapping with the second bandwidth 310, a second frequency portion 335 that is different in frequency from (non-overlapping with, distinct from) the second bandwidth 310, and a third frequency portion 340 of the second bandwidth 310 that is different in frequency from (non-overlapping with, distinct from) the first bandwidth 315. In some implementations, the primary channel 345 and the primary channel 350 may be a same channel, and occupy a same set of frequency resources of the first frequency portion 330. In other examples, the primary channel 345 and the primary channel 350 may be different channels, occupying different sets of frequency resources of the first frequency portion 330. The different sets of frequency resources may be fully different in some examples, or may be partially overlapping.

The primary channel of an AP, including the primary channels 345 and the primary channels 350 may be used by the respective AP 105-b and the AP 105-a to monitor for incoming packets. In some implementations, for a shared TXOP, the primary channel 345 and the primary channel 350 may be in the first frequency portion 330 that is overlapping between the first bandwidth 315 and the second bandwidth 310. Non-HT duplicate PPDUs may be used for signaling exchanges between the AP 105-a and the AP 105-b.

In some implementations, one or both of the first bandwidth 315 and the second bandwidth 310 may operate using channels in or adjacent Unlicensed National Information Infrastructure (U-NII) radio frequency spectrum bands U-NII-5, U-NII-6, U-NII-7, or U-NII-8. Such channels may include 20 MHz, 40 MHz, 80 MHz, 160 MHz, or 320 MHz bandwidths. In some implementations, first bandwidth 315 may be a 320 MHz bandwidth, such as in one or more of U-NII-5, U-NII-6, U-NII-7, or U-NII-8, and second bandwidth 310 may be a 320 MHz bandwidth, such as in one or more of U-NII-5, U-NII-6, U-NII-7, or U-NII-8.

The first bandwidth 315 and the second bandwidth 310 may each use a resource unit (RU) allocation that is the same or different, for example for data communications, in first frequency portion 330 that is overlapping between the first bandwidth 315 and the second bandwidth 310.

With reference to FIG. 3C, frequency resource allocation 303 may include a first bandwidth 315 of AP 105-a, including a primary channel 370. For example, the first bandwidth 315 may be a wideband wireless channel and may be 20 MHz, 40 MHz, 80 MHz, 160 MHz, 320 MHz, or more, that includes the primary channel 370 and one or more secondary channels. The primary channel 370 may be a 20 MHz channel. In other examples, the primary channel may be a 40 MHz, 80 MHz, or 160 MHz channel. The secondary channels may be 20 MHz, 40 MHz, 80 MHz, or 160 MHz channels.

Frequency resource allocation 302 also may include a second bandwidth 355 of AP 105-b, including a primary channel 365. For example, the second bandwidth 355 may be a wideband wireless channel and may be 20 MHz, 40 MHz, 80 MHz, 160 MHz, 320 MHz, or more, that includes primary channel 345 and one or more secondary channels. The primary channel 365 may be a 20 MHz channel. In other examples, the primary channel may be a 40 MHz, 80 MHz, or 160 MHz channel. The secondary channels may be 20 MHz, 40 MHz, 80 MHz, or 160 MHz channels.

Frequency resource allocation 302 illustrates an example frequency resource allocation where the first bandwidth 315 and the second bandwidth 310 at least partially overlap. In some implementations, the second bandwidth 310 is a portion of or includes a subset of frequency resources of the first bandwidth 315, such that there is a first frequency portion 330 that is overlapping with the second bandwidth 310 and a second frequency portion 335 that is different in frequency from (non-overlapping with, distinct from) the second bandwidth 355. In some implementations, the primary channel 365 and the primary channel 370 may be a same channel, and occupy a same set of frequency resources of the first frequency portion 330. In other examples, the primary channel 365 and the primary channel 370 may be different channels, occupying different sets of frequency resources of the first frequency portion 330. The different sets of frequency resources may be fully different in some examples, or may be partially overlapping.

In some implementations, one or both of first bandwidth 315 and second bandwidth 355 may operate using channels in or adjacent Unlicensed National Information Infrastructure (U-NII) radio frequency spectrum bands U-NII-5, U-NII-6, U-NII-7, or U-NII-8. Such channels may include 20 MHz, 40 MHz, 80 MHz, 160 MHz, or 320 MHz bandwidths. In some implementations, first bandwidth 315 may be a 40 MHz, 80 MHz, 160 MHz, or 320 MHz bandwidth, such as in one or more of U-NII-5, U-NII-6, U-NII-7, or U-NII-8, and second bandwidth 355 may be a 20 MHz, 40 MHz, 80 MHz, 160 MHz, bandwidth, smaller or narrower than the first bandwidth 315, such as in one or more of U-NII-5, U-NII-6, U-NII-7, or U-NII-8.

The first bandwidth 315 and second bandwidth 355 may each use a resource unit (RU) allocation that is the same or different, for example for data communications, in first frequency portion 330 that is overlapping between the first bandwidth 315 and the second bandwidth 355.

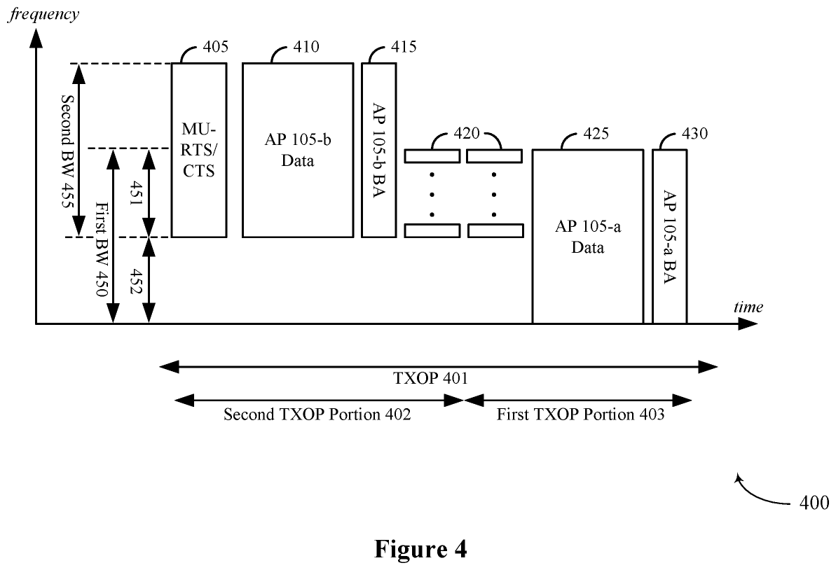

FIG. 4 shows a timing diagram 400 illustrating an example of communications that support C-TDMA among APs with different channels. The AP 105-a may be an example of the AP 105-a of FIG. 1 or the AP 105-a of FIG. 2, FIG. 3A, FIG. 3B, or FIG. 3C. The AP 105-b may be an example of AP 105-b of FIG. 1 or AP 105-b of FIG. 2, FIG. 3A, FIG. 3B, or FIG. 3C.

The AP 105-a may have an operating bandwidth that is the first bandwidth 450. The AP 105-b may have an operating bandwidth that is the second bandwidth 455 that overlaps with the first bandwidth 450 for the first frequency portion 451 and is different from (non-overlapping) with the first bandwidth 450 for the second frequency portion 452. In some implementations, the first bandwidth 450 and the second bandwidth 455 may be configured differently, for example consistent with one or more of the frequency resource allocation 302 of FIG. 3B or the frequency resource allocation 303 of FIG. 3C.

The AP 105-b may be the TXOP owner for the TXOP 401, having secured the wireless medium including the second bandwidth 455 for TXOP 401. During the MU-RTS/CTS exchange 405, the AP 105-b may provide scheduling information identifying the first TXOP portion 403 for the AP 105-a as part of the shared TXOP of TXOP 401. The AP 105-b may use the second TXOP portion 402. The AP 105-b may communicate the data communications 410 to STAs of the BSS of the AP 105-b, and such STAs may provide acknowledgements, such as the BA 415 in response.

The AP 105-b and the AP 105-a may exchange the control signaling 420 at or near the beginning of the first TXOP portion 403. Such control signaling 420 may be in non-HT duplicate PPDUs, for example receivable by APs using different channel settings. For example the AP 105-b may transmit the control signaling 420, such as a trigger for the AP 105-a to use the first TXOP portion 403, where the AP 105-a and the AP 105-b use primary channels in different frequency resources within the first frequency portion 451. The control signaling 420 may include an MU-RTS transmitted by the AP 105-b, and a CTS transmitted by the AP 105-a. The AP 105-a may communicate the data communications 425 to STAs of the BSS of the AP 105-a, and such STAs may provide acknowledgements, such as the BA 430 in response. The AP 105-a may communicate data both in the portions of the first bandwidth 450, the first frequency portion 451, that overlaps with the second bandwidth 455, and also in the portions of the first bandwidth 450 different from or non-overlapping with the second bandwidth 455. Similarly, acknowledgements, such as the BA 430, may be transmitted both in the first frequency portion 451 and the second frequency portion 452.

In some example, the AP 105-a may perform a backoff procedure, such as a random backoff procedure, and CCA before performing the data communications 425 in the first TXOP portion 403. Additionally to CCA, or alternatively to CCA, AP 105-a may perform packet detection. AP 105-a may perform the backoff procedure and CCA in the non-overlapping, the second frequency portion 452, for example for one or more subchannels within the second frequency portion 452. In some implementations, the AP 105-a may use a first or primary radio to perform CCA, packet detection, or both, on the overlapping, the first frequency portion 451, and a second or auxiliary radio to perform CCA, packet detection, or both, on the second frequency portion 452. In other examples, the AP 105-a may receive the scheduling information from the AP 105-b in an Mu-RTS during the MU-RTS/CTS exchange 405 using the radio of AP 105-a tuned to receive in at least a portion of the second bandwidth 455, and tune the radio, packet detection logic, or both, to perform CCA, packet detection, or both, on at least the second frequency portion 452 according to the scheduling information identifying the first TXOP portion 403. The AP 105-a may proceed to perform the data communications 425 in the first TXOP portion 403 following the countdown of the backoff timer of the backoff procedure and CCA indicating idle for the non-overlapping second frequency portion 452.

In some implementations, the AP 105-a may detect that the first frequency portion 451 is occupied by a transmission from the AP 105-b during the second TXOP portion 402, for example by performing the CCA during the second TXOP portion 402. The AP 105-a may perform, start, or continue, a backoff countdown of a backoff procedure for the first frequency portion 451 during the second TXOP portion 402. The backoff countdown may be a new backoff or a continuation of an existing backoff started prior to the AP 105-a receiving control signaling 420. The CCA associated with the second frequency portion 452 may be performed in the first TXOP portion 403 following completion of the backoff procedure.

For example, the AP 105-a may continue the countdown of a backoff timer for the backoff procedure after receiving the scheduling information from the AP 105-b in an MU-RTS during the MU-RTS/CTS exchange 405. In some implementations, the AP 105-a may perform the backoff procedure, such as the countdown of an backoff timer that has already been started or the start of a new backoff timer in the second TXOP portion 402, despite the data communications 410 or the BA 415. In some implementations, the AP 105-a may pause the countdown in the second TXOP portion 402 if the AP 105-a detects transmissions from devices other than the AP 105-b. Such devices may be from an overlapping basic service set (OBSS) network. To detect such transmissions, the AP 105-a may use packet-in-packet detection, a change in a receive signal level, or both. In some implementations, the AP 105-a may listen on a primary channel for such detection, such as a primary 20 MHz channel of the first frequency portion 451 that overlaps with the second bandwidth 455 of the TXOP owner AP 105-b. The AP 105-a may proceed to perform the data communications 425 in the first TXOP portion 403 following the countdown of the backoff timer of the backoff procedure and CCA indicating idle for the non-overlapping second frequency portion 452.

In another example, the AP 105-a may ignore a countdown of a backoff counter and proceed to perform the data communications 425 in the first TXOP portion 403 if a CCA at the beginning of the first TXOP portion 403 indicates idle or clear for the non-overlapping second frequency portion 452. The CCA may be performed during a SIFS or PIFS window before the AP 105-a proceeds to perform communications, for example the data communications 425, during the TXOP portion 403. In other examples, the CCA may be performed during the SIFS window within 420, between the MU-RTS and CTS. In some implementations, the AP 105-a may have a value for the backoff counter that is non-zero, but proceed to CCA despite the non-zero value.

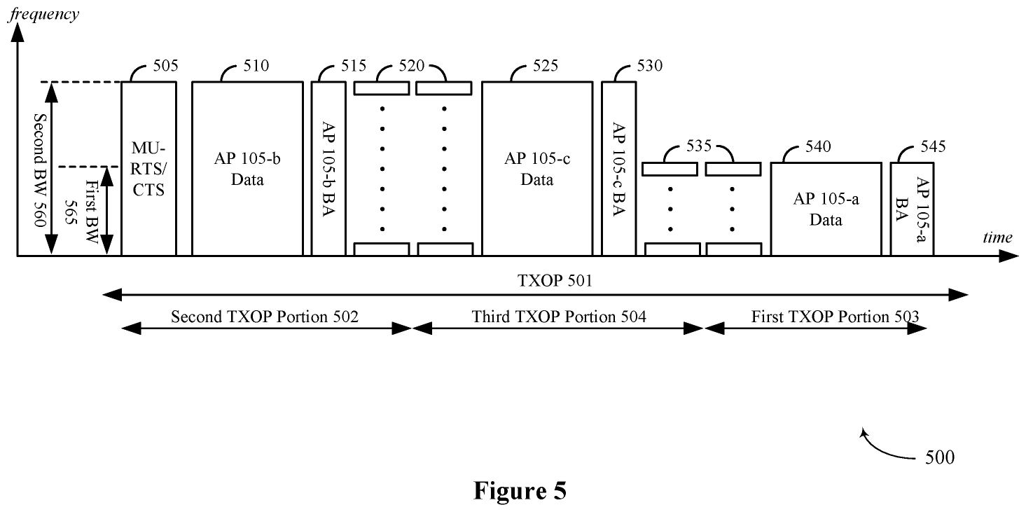

FIG. 5 shows a timing diagram 500 illustrating an example of communications that support C-TDMA among APs with different channels. AP 105-a may be an example of AP 105-a of FIG. 1 or AP 105-a of FIG. 2, FIG. 3A, FIG. 3B, FIG. 3C, or FIG. 4. The AP 105-b may be an example of the AP 105-b of FIG. 1 or the AP 105-b of FIG. 2, FIG. 3A, FIG. 3B, FIG. 3C, or FIG. 4. The AP 105-c may be a third AP sharing a TXOP 501, for example another AP of an ESS than also includes the AP 105-a and the AP 105-b.

The AP 105-a may have an operating bandwidth that is the first bandwidth 565. The AP 105-b and the AP 105-c may have an operating bandwidth that is the second bandwidth 560 that overlaps with the first bandwidth 565.

The AP 105-b may be the TXOP owner for the TXOP 501, having secured the wireless medium including the second bandwidth 560 for the TXOP 501. During the MU-RTS/CTS exchange 505, the AP 105-b may provide scheduling information identifying the first TXOP portion 503 for the AP 105-a and the third TXOP portion 504 for the AP 105-c as part of the shared TXOP of the TXOP 501. The AP 105-b may use the second TXOP portion 502. The AP 105-b may communicate the data 510 to STAs of the BSS of the AP 105-b, and such STAs may provide acknowledgements, such as the BA 515 in response.

The AP 105-b and the AP 105-c may exchange the control signal 520 at or near the beginning of the third TXOP portion 504. Such control signaling 420 may be in non-HT duplicate PPDUs, for example receivable by APs using different channel settings. For example the AP 105-b may transmit the control signal 520, such as a MU-RTS for the AP 105-c to use the third TXOP portion 504. The AP 105-b and the AP 105-c may use primary channels in different frequency resources within the second bandwidth 506. The control signal 520 may include an MU-RTS for AP 105-c, transmitted by the AP 105-b, and a CTS transmitted by the AP 105-c. The AP 105-c may communicate the data 525 to STAs of the BSS of AP 105-c, and such STAs may provide acknowledgements, such as the BA 530 in response.

Following third TXOP portion 504, AP 105-b and AP 105-a may exchange the control signal 535 at or near the beginning of the first TXOP portion 503. Control signal 535 may be in non-HT duplicate PPDUs, for example receivable by APs using different channel settings, here transmitted in the first bandwidth 565, which is a portion or subset of the second bandwidth 560. In other examples, the control signal 535 may be transmitted by the AP 105-b over the second bandwidth 560, but a portion of control signal 535 received by the AP 105-a over first bandwidth 565. The AP 105-b may transmit the control signal 535, such as an MU-RTS for the AP 105-a to use the first TXOP portion 503. In some implementations, the AP 105-a and the AP 105-b use primary channels in different frequency resources within the first bandwidth 565. The control signal 535 may include an MU-RTS from the AP 105-b and a CTS from the AP 105-a. The AP 105-a may communicate the data 540 to STAs of the BSS of the AP 105-a, and such STAs may provide acknowledgements, such as the BA 545 in response. The AP 105-a may communicate data over the first bandwidth 565.

In some examples, there may be a requirement that where an AP has shared or granted a portion of the TXOP of the AP with one or more other APs, those APs may start transmitting on a channel, such as a 20 MHz channel (subchannel), of their own operating bandwidth in the TXOP only if that channel, such as a 20 MHz channel, overlaps in frequency with preceding channels, including the channels (subchannels) of the TXOP owner AP. According to such a requirement, bandwidth for each successively-scheduled AP within the shared TXOP will have the bandwidth on which it may transmit constrained to be no more than the bandwidth of the immediately preceding AP.

For example, if the secondly-scheduled AP in the TXOP has a smallest operating bandwidth among the non-TXOP owner APs in the shared TXOP, all subsequent non-TXOP owner APs in the TXOP may be able to use no more than the smallest bandwidth during the TXOP, even if the subsequent non-TXOP owner APs have a larger operating bandwidth. As such, the TXOP owner AP 105-b may schedule the AP 105-a (of the first TXOP portion 503) at or toward the end of TXOP 501 where one or more other participating APs are schedule within the TXOP 501 having a larger bandwidth, so that the bandwidth of the TXOP is not reduced for the other participating APs.

For example, the third TXOP portion 504 may be scheduled between the second TXOP portion 502 and the first TXOP portion 503 between the AP 105-c uses an operating bandwidth that is equal to or no smaller than the second bandwidth 560 of the AP 105-b, while the first bandwidth 565 of the AP 105-a is smaller or narrower than the first bandwidth 565. As such, the bandwidth available to the AP 105-c during the third TXOP portion 504 may not be restricted by having the first TXOP portion 503 for the AP 105-a scheduled prior to the third TXOP portion 504 within the TXOP 501. In one example, the AP 105-b may schedule participating APs, such as the AP 105-a and the AP 105-b, of the TXOP from largest or widest bandwidth to smallest or narrowest bandwidth to minimize the constraint on bandwidth for the participating APs during the TXOP.

In some implementations, a participant AP may be restricted or restrict itself to schedule downlink transmissions to the wireless device such that the responses (such as BA or data transmissions) that the participant AP receives from wireless devices during a shared TXOP comply with a count threshold, a duration threshold, or both. Such participant APs may include APs having different operating bandwidths than a TXOP owner AP. For example the participant AP may be the AP 105-a of FIG. 1 or the AP 105-a of FIGS. 2 through 5. The one or more other wireless devices may include APs or STAs.

As part of sharing the TXOP, the participant AP may be restricted or restrict itself to schedule downlink transmissions, such as during the TXOP portion scheduled for the participant AP by the TXOP owner AP, to the wireless device such that the responses that the participant AP receives from the wireless devices comply with a count threshold, a duration threshold, or both, applicable to rules for TXOP sharing. For example, the participant AP may limit or otherwise control the minimum interval between the acknowledgement frames and the total duration from a wireless device or client, for example, by adjusting the length and frequency of the PPDUs sent to the wireless device or client. Controlling the count and duration may allow for fairness to other APs scheduling stations of their respective BSSs to comply with count and duration rules for uplink transmissions during the shared TXOP. These techniques may be applicable for a participant AP and TXOP owner AP having different bandwidths, and also when they have a same bandwidth. Also, such techniques may apply to C-OFDMA and coordinated scheduling request (C-SR) communications. In some implementations, these techniques also may apply to a TXOP shared to a STA for the data exchange between the STA and another STA over a peer-to-peer link during the shared TXOP. For example, after the AP 105-a in FIG. 1 wins a TXOP by itself based on contention, the AP 105-a may share a portion of the TXOP to STA 116. This sharing may enable a STA 116 and a STA 117 to exchange data over a peer-to-peer link (such as TDLS) between the two STAs during the shared TXOP. In this case, the STA 116 may limit or otherwise control the minimum interval between the frames and the total duration for the frames received from the STA 117, for example, by adjusting the length and frequency of the PPDUs sent to the STA 117, to comply with count and duration rules for frames received during a shared TXOP in certain region or country.

In some implementations, a participant AP of a shared TXOP may grant a sub-portion (sub-grant a portion) or portions of the scheduled TXOP portion of the participant AP to one or more other wireless devices. Such participant APs may include APs having different operating bandwidths than the TXOP owner AP. For example the participant AP may be the AP 105-a of FIG. 1 or AP 105-a of FIGS. 2 through 5. The one or more other wireless devices may include APs or STAs. As part of the grant, the participant AP may schedule transmissions, and may be able to schedule more uplink transmissions. In some implementations, to be friendly or fair to existing devices in the field, the participant AP may perform a CCA check in a SIFS or PIFS window to ensure the medium is clear before sub-granting a shared TXOP to a wireless device. The wireless device also may perform a CCA check in a SIFS or PIFS window in the sub-granted TXOP to ensure the medium is clear before transmitting. These techniques may be applicable for a participant AP and TXOP owner AP having different bandwidths, and also when they have a same bandwidth. Additionally, such techniques may apply to C-OFDMA and C-SR communications.

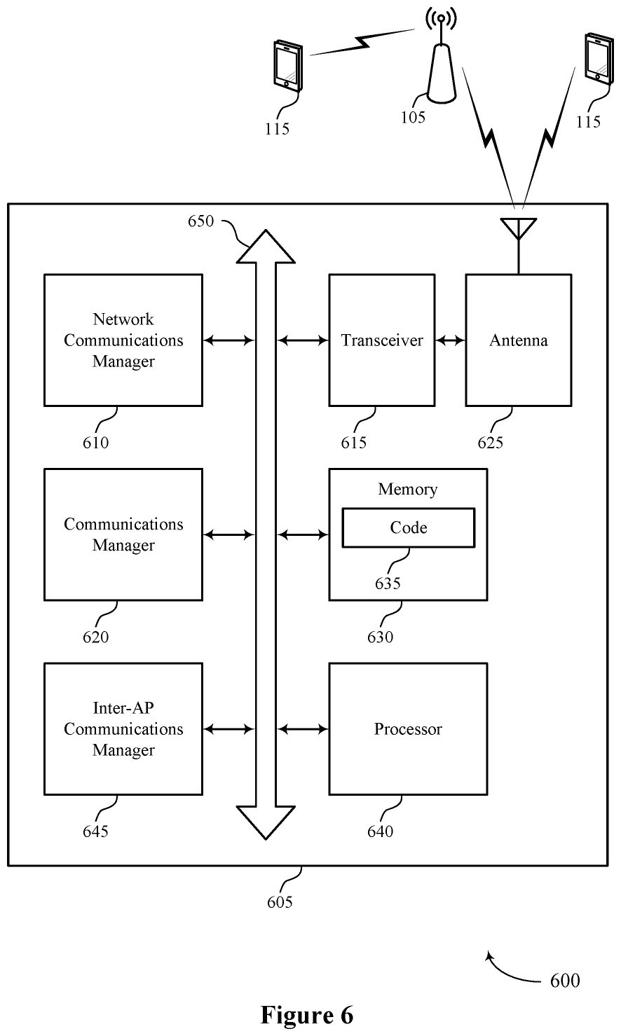

FIG. 6 shows an example diagram of a system 600 including a device 605 that supports C-TDMA among APs with different channels. The device 605 may be an AP, for example an example of AP 105 of FIG. 1 or an AP, such as AP 105-a, of any of FIGS. 2 through 5.

The device 605 may include components for bi-directional voice and data communications including components for transmitting and receiving communications, such as a communications manager 620, a network communications manager 610, a transceiver 615, an antenna 625, a memory 630, code 635, a processor 640, and an inter-AP communications manager 645. These components may be in electronic communication or otherwise coupled (such as, operatively, communicatively, functionally, electronically, electrically) via one or more buses (such as, a bus 650).

The network communications manager 610 may manage communications with a core network (such as, via one or more wired backhaul links). For example, the network communications manager 610 may manage the transfer of data communications for client devices, such as one or more STAs 115.

In some implementations, the device 605 may include a single antenna 625. However, in some other implementations the device 605 may have more than one antenna 625, which may be capable of concurrently transmitting or receiving multiple wireless transmissions. The transceiver 615 may communicate bi-directionally, via the one or more antennas 625, wired, or wireless links as described herein. For example, the transceiver 615 may represent a wireless transceiver and may communicate bi-directionally with another wireless transceiver. The transceiver 615 also may include a modem to modulate the packets and provide the modulated packets to one or more antennas 625 for transmission, and to demodulate packets received from the one or more antennas 625. The transceiver 615, or the transceiver 615 and one or more antennas 625, may be an example of a transmitter, a receiver, or any combination thereof or component thereof.

The memory 630 may include RAM and ROM. The memory 630 may store computer-readable, computer-executable code 635 including instructions that, when executed by the processor 640, cause the device 605 to perform various functions described herein. In some implementations, the memory 630 may contain, among other things, a BIOS which may control basic hardware or software operation such as the interaction with peripheral components or devices.

The processor 640 may include an intelligent hardware device, (such as, a general-purpose processor, a DSP, a CPU, a microcontroller, an ASIC, an FPGA, a programmable logic device, a discrete gate or transistor logic component, a discrete hardware component, or any combination thereof). In some implementations, the processor 640 may be configured to operate a memory array using a memory controller. In some other implementations, a memory controller may be integrated into the processor 640. The processor 640 may be configured to execute computer-readable instructions stored in a memory (such as, the memory 630) to cause the device 605 to perform various functions (such as, functions or tasks supporting coordinated time domain multiple access among APs with different channels). For example, the device 605 or a component of the device 605 may include a processor 640 and memory 630 coupled with or to the processor 640, the processor 640 and memory 630 configured to perform various functions described herein.

The inter-AP communications manager 645 may manage communications with other APs 105, and may include a controller or scheduler for controlling communications with STAs 115 in cooperation with other APs 105. For example, the inter-AP communications manager 645 may coordinate scheduling for TXOP portions of a shared TXOP among to APs 105 for C-TDMA, for example for APs that use different channels as further described herein. In some implementations, the inter-AP communications manager 645 may coordinate scheduling for transmissions to APs 105 for various interference mitigation techniques such as beamforming or joint transmission. In some implementations, the inter-AP communications manager 645 may provide an interface to provide communication between APs 105.

The communications manager 620 may support wireless communication at a first wireless AP in accordance with examples as disclosed herein. For example, the communications manager 620 may be configured as or otherwise support a means for receiving, from a second wireless AP operating in a second bandwidth, a first control message indicating scheduling information for at least the first wireless AP to transmit or receive packets during a TXOP, the first wireless AP operating in a first bandwidth that includes a first frequency portion that is overlapping in frequency with the second bandwidth and a second frequency portion that is different in frequency from the second bandwidth. The communications manager 620 may be configured as or otherwise support a means for performing, during the TXOP, a CCA associated with at least the second frequency portion of the first bandwidth. The communications manager 620 may be configured as or otherwise support a means for transmitting, in accordance with the CCA, one or more packets via the first frequency portion and the second frequency portion during at least a first portion of the TXOP granted to the first wireless AP by the scheduling information.

By including or configuring the communications manager 620 in accordance with examples as described herein, the device 605 may support techniques for coordinated time domain multiple access among APs with different channels

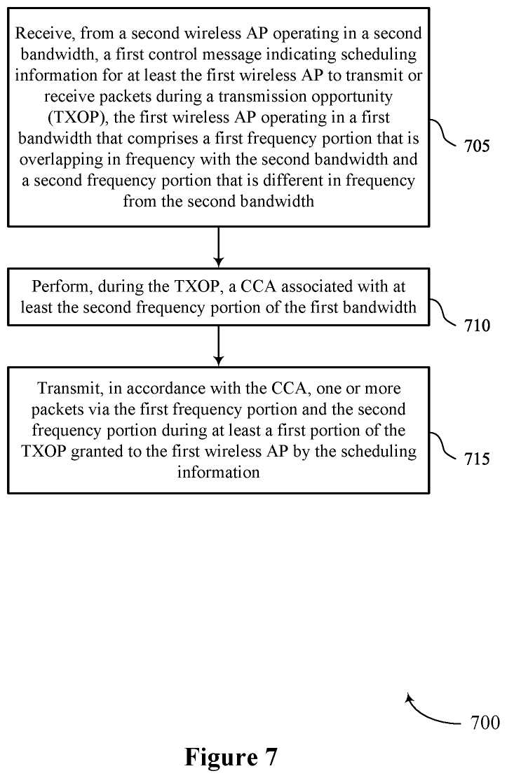

FIG. 7 shows a flowchart illustrating a method 700 that supports C-TDMA among APs with different channels. The operations of the method 700 may be implemented by an AP or its components as described herein. For example, the operations of the method 700 may be performed by an AP (which also may equivalently be referred to as a wireless AP) as described with reference to FIGS. 1 through 6, for example an AP 105-a of FIG. 1 or AP 105-a of FIGS. 2 through 6. In some implementations, an AP may execute a set of instructions to control the functional elements of the AP to perform the described functions. Additionally, or alternatively, the AP may perform aspects of the described functions using special-purpose hardware.

At 705, the method may include receiving, from a second wireless AP operating in a second bandwidth, a first control message indicating scheduling information for at least the first wireless AP to transmit or receive packets during a TXOP, the first wireless AP operating in a first bandwidth that includes a first frequency portion that is overlapping in frequency with the second bandwidth and a second frequency portion that is different in frequency from the second bandwidth. The operations of 705 may be performed in accordance with examples as disclosed herein.

At 710, the method may include performing, during the TXOP, a CCA associated with at least the second frequency portion of the first bandwidth. The operations of 710 may be performed in accordance with examples as disclosed herein.

At 715, the method may include transmitting, in accordance with the CCA, one or more packets via the first frequency portion and the second frequency portion during at least a first portion of the TXOP granted to the first wireless AP by the scheduling information. The operations of 715 may be performed in accordance with examples as disclosed herein.

The methods described herein describe possible implementations, and that the operations and the steps may be rearranged or otherwise modified and that other implementations are possible. Furthermore, aspects from two or more of the methods may be combined.

The following provides an overview of aspects of the present disclosure:

Aspect 1: A method for wireless communication at a first wireless AP, including: receiving, from a second wireless AP operating in a second bandwidth, a first control message indicating scheduling information for at least the first wireless AP to transmit or receive packets during a transmission opportunity (TXOP), the first wireless AP operating in a first bandwidth that includes a first frequency portion that is overlapping in frequency with the second bandwidth and a second frequency portion that is different in frequency from the second bandwidth; performing, during the TXOP, a CCA associated with at least the second frequency portion of the first bandwidth; and transmitting, in accordance with the CCA, one or more packets via the first frequency portion and the second frequency portion during at least a first portion of the TXOP granted to the first wireless AP by the scheduling information.

Aspect 2: The method of aspect 1, further including: receiving a second control message prior to the first control message indicating scheduling information for a second portion of the TXOP that precedes the first portion of the TXOP.

Aspect 3: The method of aspect 2, further including: detecting the first frequency portion is occupied by a transmission from the second wireless AP during the second portion of the TXOP; and performing a backoff countdown of a backoff procedure for the first frequency portion during the second portion of the TXOP, where the CCA associated with the second frequency portion is performed in the first portion of the TXOP following completion of the backoff procedure.

Aspect 4: The method of aspect 3, further including: pausing the backoff countdown in response to detecting a transmission from a wireless device.

Aspect 5: The method of any of aspects 3 through 4, further including: performing, during the TXOP, the CCA associated with the first frequency portion in the first portion of the TXOP following completion of the backoff procedure.

Aspect 6: The method of any of aspects 2 through 5, further including: performing a backoff countdown of a backoff procedure in the second frequency portion during the second portion of the TXOP, where the CCA associated with the second frequency portion is performed in the first portion of the TXOP following completion of the backoff procedure; and performing the CCA associated with the first frequency portion of the first bandwidth, where the one or more packets are transmitted in accordance with the CCA associated with both the first frequency portion and the second frequency portion.

Aspect 7: The method of aspect 6, further including: tuning a radio of the first wireless AP to at least one subchannel of the first portion of the first bandwidth to monitor for the second control message indicating the scheduling information; and tuning the radio of the first wireless AP to at least one subchannel of the second portion of the first bandwidth in response to obtaining the scheduling information.

Aspect 8: The method of any of aspects 1 through 7, where performing the CCA includes: performing the CCA associated with the second frequency portion during an inter-frame spacing window of the first portion of the TXOP.

Aspect 9: The method of any of aspects 1 through 8, where performing the CCA includes: performing the CCA associated with the second frequency portion during the first portion of the TXOP regardless of whether a backoff countdown for the first wireless AP has completed.

Aspect 10: The method of any of aspects 1 through 9, further including: selecting a length, a frequency or both, of the one or more packets to transmit to a first wireless STA in accordance with a threshold count, a threshold duration, or both, for one or more packets to be received from the first wireless STA.

Aspect 11: The method of any of aspects 1 through 10, further including: transmitting, to a second STA, an indication of a grant of a sub-portion of the first portion of the TXOP granted to the first wireless AP by the scheduling information, where the second STA performs a CCA prior to transmitting during the sub-portion.

Aspect 12: The method of any of aspects 1 through 11, further including: performing the CCA associated with the first frequency portion of the first bandwidth using a first radio of the first wireless AP, where the CCA associated with the second frequency portion of the first bandwidth is performing using a second radio of the first wireless AP.

Aspect 13: The method of aspect 12, where the CCA associated with the second frequency portion of the first bandwidth is performed following completion of a backoff procedure associated with the second radio.

Aspect 14: The method of any of aspects 1 through 13, where the first wireless AP is of a first basic service set (BSS) and the second wireless AP is of a second BSS.

Aspect 15: An apparatus for wireless communication at a first wireless AP, including a processor; memory coupled with the processor; and instructions stored in the memory and executable by the processor to cause the apparatus to perform a method of any of aspects 1 through 14.

Aspect 16: An apparatus for wireless communication at a first wireless AP, including at least one means for performing a method of any of aspects 1 through 14.

Aspect 17: A non-transitory computer-readable medium storing code for wireless communication at a first wireless AP, the code including instructions executable by a processor to perform a method of any of aspects 1 through 14.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, and the like. Also, “determining” can include receiving (such as receiving information), accessing (such as accessing data stored in memory) and the like. Also, “determining” can include resolving, selecting, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented using hardware or software depends upon the particular application and design constraints imposed on the overall system.

The hardware and data processing apparatus used to implement the various illustrative logics, logical blocks, modules and circuits described in connection with the aspects disclosed herein may be implemented or performed using a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented using hardware, digital electronic circuitry, computer software, firmware, including the structures disclosed in this specification and their structural equivalents thereof, or in any combination thereof. Implementations of the subject matter described in this specification also can be implemented as one or more computer programs, such as one or more modules of computer program instructions, encoded on a computer storage media for execution by, or to control the operation of, data processing apparatus.

If implemented in software, the functions may be stored on or transmitted using one or more instructions or code of a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one location to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc. Disks may reproduce data magnetically and discs may reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in some combinations and even initially claimed as such, one or more features from a claimed combination can be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some implementations, the actions recited in the claims can be performed in a different order and still achieve desirable results.

What is claimed is:

1. An apparatus for wireless communication at a first wireless access point (AP), comprising:
one or more interfaces configured to:
obtain, from a second wireless AP operating in a second bandwidth, a first control message indicating scheduling information for at least the first wireless AP to transmit or receive packets during a transmission opportunity (TXOP), the first wireless AP operating in a first bandwidth that comprises a first frequency portion that is overlapping in frequency with the second bandwidth and a second frequency portion that is different in frequency from the second bandwidth; and
output one or more packets via the first frequency portion and the second frequency portion during at least a first portion of the TXOP granted to the first wireless AP by the scheduling information; and
a processing system configured to:
perform, during the TXOP, a clear channel assessment (CCA) associated with at least the second frequency portion of the first bandwidth, wherein the one or more packets are output in accordance with the CCA.

2. The apparatus of claim 1, wherein the one or more interfaces are configured to:
obtain a second control message prior to the first control message indicating scheduling information for a second portion of the TXOP that precedes the first portion of the TXOP.

3. The apparatus of claim 2, wherein the processing system is configured to:
detect the first frequency portion is occupied by a transmission from the second wireless AP during the second portion of the TXOP; and
perform a backoff countdown of a backoff procedure for the first frequency portion during the second portion of the TXOP, wherein the CCA associated with the second frequency portion is performed in the first portion of the TXOP following completion of the backoff procedure.

4. The apparatus of claim 3, wherein the processing system is configured to:
pause the backoff countdown in response to detecting a transmission from a wireless device.

5. The apparatus of claim 3, wherein the processing system is configured to:
perform, during the TXOP, the CCA associated with the first frequency portion in the first portion of the TXOP following completion of the backoff procedure.

6. The apparatus of claim 2, wherein the processing system is configured to:
perform a backoff countdown of a backoff procedure in the second frequency portion during the second portion of the TXOP, wherein the CCA associated with the second frequency portion is performed in the first portion of the TXOP following completion of the backoff procedure; and
perform the CCA associated with the first frequency portion of the first bandwidth, wherein the one or more packets are transmitted in accordance with the CCA associated with both the first frequency portion and the second frequency portion.

7. The apparatus of claim 6, wherein the processing system is configured to:
tune a radio of the first wireless AP to at least one subchannel of the first portion of the first bandwidth to monitor for the second control message indicating the scheduling information; and
tune the radio of the first wireless AP to at least one subchannel of the second portion of the first bandwidth in response to obtaining the scheduling information.

8. The apparatus of claim 1, wherein, to perform the CCA, the processing system is further configured to:
perform the CCA associated with the second frequency portion during an inter-frame spacing window of the first portion of the TXOP.

9. The apparatus of claim 1, wherein, to perform the CCA, the processing system is further configured to:
perform the CCA associated with the second frequency portion during the first portion of the TXOP regardless of whether a backoff countdown for the first wireless AP has completed.

10. The apparatus of claim 1, wherein the processing system is configured to:
select a length, a frequency or both, of the one or more packets to transmit to a first wireless station (STA) in accordance with a threshold count, a threshold duration, or both, for one or more packets to be received from the first wireless STA.

11. The apparatus of claim 1, wherein the one or more interfaces are configured to:
output, to a second STA, an indication of a grant of a sub-portion of the first portion of the TXOP granted to the first wireless AP by the scheduling information, wherein the second STA performs a CCA prior to transmitting during the sub-portion.

12. The apparatus of claim 1, wherein the processing system is configured to:
perform the CCA associated with the first frequency portion of the first bandwidth using a first radio of the first wireless AP, wherein the CCA associated with the second frequency portion of the first bandwidth is performing using a second radio of the first wireless AP.

13. The apparatus of claim 12, wherein the CCA associated with the second frequency portion of the first bandwidth is performed following completion of a backoff procedure associated with the second radio.

14. The apparatus of claim 1, wherein the first wireless AP uses a first primary subchannel in the first bandwidth, the second wireless AP uses a second primary subchannel in the second bandwidth, and the first primary subchannel is different in frequency than the second primary subchannel.

15. The apparatus of claim 1, wherein the first wireless AP uses a first primary subchannel in the first bandwidth, the second wireless AP uses a second primary subchannel in the second bandwidth, and the first primary subchannel is a same frequency as the second primary subchannel.

16. The apparatus of claim 1, wherein the first wireless AP is of a first basic service set (BSS) and the second wireless AP is of a second BSS.

17. A method for wireless communication at a first wireless access point (AP), comprising:
receiving, from a second wireless AP operating in a second bandwidth, a first control message indicating scheduling information for at least the first wireless AP to transmit or receive packets during a transmission opportunity (TXOP), the first wireless AP operating in a first bandwidth that comprises a first frequency portion that is overlapping in frequency with the second bandwidth and a second frequency portion that is different in frequency from the second bandwidth;
performing, during the TXOP, a clear channel assessment (CCA) associated with at least the second frequency portion of the first bandwidth; and
transmitting, in accordance with the CCA, one or more packets via the first frequency portion and the second frequency portion during at least a first portion of the TXOP granted to the first wireless AP by the scheduling information.

18. The method of claim 17, further comprising:
receiving a second control message prior to the first control message indicating scheduling information for a second portion of the TXOP that precedes the first portion of the TXOP.

19. The method of claim 18, further comprising:
detecting the first frequency portion is occupied by a transmission from the second wireless AP during the second portion of the TXOP; and
performing a backoff countdown of a backoff procedure for the first frequency portion during the second portion of the TXOP, wherein the CCA associated with the second frequency portion is performed in the first portion of the TXOP following completion of the backoff procedure.

20. The method of claim 19, further comprising:
pausing the backoff countdown in response to detecting a transmission from a wireless device.

21. The method of claim 19, further comprising:
performing, during the TXOP, the CCA associated with the first frequency portion in the first portion of the TXOP following completion of the backoff procedure.

22. The method of claim 18, further comprising:
performing a backoff countdown of a backoff procedure in the second frequency portion during the second portion of the TXOP, wherein the CCA associated with the second frequency portion is performed in the first portion of the TXOP following completion of the backoff procedure; and
performing the CCA associated with the first frequency portion of the first bandwidth, wherein the one or more packets are transmitted in accordance with the CCA associated with both the first frequency portion and the second frequency portion.

23. The method of claim 22, further comprising:
tuning a radio of the first wireless AP to at least one subchannel of the first portion of the first bandwidth to monitor for the second control message indicating the scheduling information; and
tuning the radio of the first wireless AP to at least one subchannel of the second portion of the first bandwidth in response to obtaining the scheduling information.

24. The method of claim 17, wherein performing the CCA comprises:
performing the CCA associated with the second frequency portion during an inter-frame spacing window of the first portion of the TXOP.

25. The method of claim 17, wherein performing the CCA comprises:
performing the CCA associated with the second frequency portion during the first portion of the TXOP regardless of whether a backoff countdown for the first wireless AP has completed.

26. The method of claim 17, further comprising:
selecting a length, a frequency or both, of the one or more packets to transmit to a first wireless station (STA) in accordance with a threshold count, a threshold duration, or both, for one or more packets to be received from the first wireless STA.

27. The method of claim 17, further comprising:
transmitting, to a second STA, an indication of a grant of a sub-portion of the first portion of the TXOP granted to the first wireless AP by the scheduling information, wherein the second STA performs a CCA prior to transmitting during the sub-portion.

28. The method of claim 17, further comprising:
performing the CCA associated with the first frequency portion of the first bandwidth using a first radio of the first wireless AP, wherein the CCA associated with the second frequency portion of the first bandwidth is performing using a second radio of the first wireless AP.

29. The method of claim 28, wherein the CCA associated with the second frequency portion of the first bandwidth is performed following completion of a backoff procedure associated with the second radio.

30. The method of claim 17, wherein the first wireless AP is of a first basic service set (BSS) and the second wireless AP is of a second BSS.
